(19) United States
(12) Patent Application Publication
(10) Pub. No.: US 2011/0148171 A1
(43) Pub. Date: Jun. 23, 2011

(54) HEIGHT ADJUSTABLE HEADREST FOR AN AUTOMOBILE SEAT BACKREST

(75) Inventors: Philippe CHARLES, Luxeuil Les Bains (FR); Christophe Remy, Le Clerjus (FR)

(73) Assignee: Faurecia Sieges D'Automobile, Nanterre (FR)

(21) Appl. No.: 12/976,233

(22) Filed: Dec. 22, 2010

(30) Foreign Application Priority Data
Dec. 23, 2009 (FR) 09/59559

(51) Int. Cl. B60N 2/48

(52) U.S. Cl. 297/410

(57) ABSTRACT

A headrest including fixed rods intended to be secured on the backrest and extending substantially vertically, a mobile frame slidably assembled on the rods, and a lock associated with the mobile frame and slidably guided thereon along a horizontal direction, to be able to lock the frame on the rods in a plurality of positions. The headrest includes a cross-piece connecting the upper ends of the rods, the cross-piece and the lock respectively including notches and teeth arranged to cooperate together to be able to lock said frame with respect to the cross-piece in any of said plurality of positions.

### BACKGROUND OF THE INVENTION

1. Field of the Invention

The present invention relates to a height-adjustable headrest for an automobile seat backrest.

2. Discussion of the Related Art

To adjust the height of a headrest, a system of sliding rods in guide bushings or other similar elements is generally used. When the rods are secured to the backrest, or at least rigidly maintained at the top of the backrest, the headrest then comprises guide means capable of sliding on the rods, and means for locking in position on the rods, to maintain the headrest in a position chosen by the user, for his best comfort and, on the other hand, to maintain the passenger's neck in case of a vehicle shock.

Notch adjustment systems in which a lock in fixed position with respect to the headrest engages with notches made in the rods are for example known. Such a system is especially described in FR 2871034, which shows a headrest frame slidably assembled on rods and comprising locking means engaging with notches made on the rods. The forming of such notches on the rods increases their cost. Further, when the headrest is in low position, it hides the notches; however, when it is raised to a high position, the notches are visible, which adversely affects the visual aspect of the headrest.

Further, lock and notch systems may be arranged in the form of a ratchet lock, to enable an easy adjustment by simple upward pulling of the headrest, but only allowing the downward motion of the headrest with a voluntary unlocking operation, to prevent the headrest from going down in the occurrence of an accident. The notches then must have a specific shape, which complicates their forming, all the more as they must be made carefully to avoid having an excessively negative impact on aesthetics, in metal rods, which are thus difficult to work. This further increases the cost of the rods.

### SUMMARY OF THE INVENTION

The present invention aims at solving the above-mentioned problems and aims at providing a novel system for adjusting the height of a headrest, in which, while the bulk of the headrest is minimized, no adjustment notch appears on the fastening rods, whatever the adjustment position of the headrest, especially when it is placed in a high position exposing a relatively large rod length. It also aims at simplifying the manufacturing of the rods and at decreasing their cost.

To achieve these objects, the present invention provides a height-adjustable headrest for an automobile seat backrest, comprising fixed rods intended to be secured to the backrest and extending substantially vertically, a mobile frame slidably assembled on the rods, and a lock associated with the mobile frame and slidably guided thereon along a horizontal direction, to be able to lock the frame on the rods in a plurality of positions.

According to the present invention, the headrest is characterized in that it comprises a cross-piece connecting the upper ends of the rods, the cross-piece and the lock respectively comprising notches and teeth arranged to cooperate together to be able to lock said frame with respect to the cross-piece in any of said plurality of positions.

Thus, no notch is formed on the rods, which accordingly have an apparent surface geometry that no longer has a functional aspect, except to guide the sliding of the headrest. The rod manufacturing is thus simplified and less expensive. The elements comprising notches, and with respect to which the headrest frame is mobile, are transferred upwards with respect to prior systems, which enables to integrally hide them inside of the frame.

According to a specific configuration, the mobile frame forms a shell that comprises a case and a cover, the case comprises added bushings slidably guided on the rods, the lock is slidably guided in the case and comprises a lateral push-button, the cross-piece and the rod being entirely hidden in the shell forming the mobile frame when the cover is secured to the case.

This configuration enables to ease the frame manufacturing and to decrease its cost, while enabling to form all the constitutive parts, apart from the rods, in moulded plastic material, and to be able to assemble them easily, as will be shown hereafter.

According to another specific configuration, the headrest comprises elastic return means for pulling back the lock to a position of engagement of the teeth with the cross-piece notches, and the notches and the teeth have slanted sides so that the lock automatically clenches when the headrest is moved upwards. Thus, for the adjustment of its height, the headrest may be manually moved upwards without having to manipulate the lock, the slanted sides of the cross-piece notches causing the sliding of the lock as a cam or a ratchet. Conversely, abrupt sides located towards the bottom for the lock teeth and towards the top for the cross-piece notches, provide an efficient locking of the headrest, preventing it from sliding downwards, especially in the occurrence of an accident, and the headrest may only be lowered by a voluntary action on the lock to disengage its teeth from the cross-piece notches.

According to a first embodiment, the cross-piece comprises a plurality of notches distributed along the sliding direction. The cross-piece is then manufactured in the general form of a plate comprising two rows of notches on a surface; the lock is assembled to be horizontally guided in translation inside of the case, sliding against said plate and comprising at least one tooth corresponding to each row of notches. The lock teeth are formed to jut out from the contact plane between the cross-piece and the lock, to be able to engage with the cross-piece notches, and to be respectively in engagement relation with a notch of each row of notches, when the lock is in locking position.

According to a second embodiment, the lock comprises a plurality of teeth distributed along the sliding direction. The lock then comprises a plate comprising two rows of teeth on a surface; the cross-piece comprises at last one notch corresponding to each row of teeth, the latter being arranged so that one of the teeth of the row of teeth is engaged with a notch of the cross-piece when the lock is in locked position.

According to other specific configurations:
the cross-piece comprises arms extending laterally and each comprising a cover force fit on the end of a rod. The assembly of the cross-piece and of the rods is thus eased.
one of the bushings for guiding the rods comprises deformable elements enabling to automatically adjust its position in the housing of the case where it is inserted, in the direction perpendicular to the sliding direction of the rods. This configuration enables to automatically adjust the distance between the centers of the bushings to that between the rod centers.
at least one of the bushings may comprise elastically deformable elements to suppress clearances between bushing and rod, this enabling to avoid any contact noise between bushings and rods.
the cross-piece is mobile between the lock and the cover, and comprises a sliding shoe against the cover, this also enabling to suppress possible clearances between the cross-piece and the headrest frame, and thus the noise that may result therefrom.

Other features and advantages will appear from the following description of a headrest system according to the present invention in connection with the accompanying drawings.

### BRIEF DESCRIPTION OF THE DRAWINGS

FIG. 1 is a front perspective view of a headrest according to the present invention,

FIG. 2 is a back perspective view of the headrest with neither upholstery nor cover, showing the plastic shell forming the headrest frame,

FIG. 3 is a back perspective view without the frame cover, in the high position of the headrest,

FIG. 4 is a similar view in the low position,

FIG. 5 is an exploded view showing the frame case supporting the lock, the rods connected by the cross-piece, and the cover for closing the case,

FIG. 6 is a planar view, from the inside of the case, illustrating the engagement of the lock with the cross-piece, not showing the headrest frame,

FIG. 7 is a corresponding planar view, from the cover side,

FIGS. 8 and 9 are views corresponding to FIGS. 3 and 4, in the case of the second embodiment,

FIG. 10 is an enlarged view of the cross-piece in the second embodiment, showing the notch arrangement,

FIG. 11 is a detailed view showing the elastic holding of the lock close to the unlocking push-button.

### DETAILED DESCRIPTION

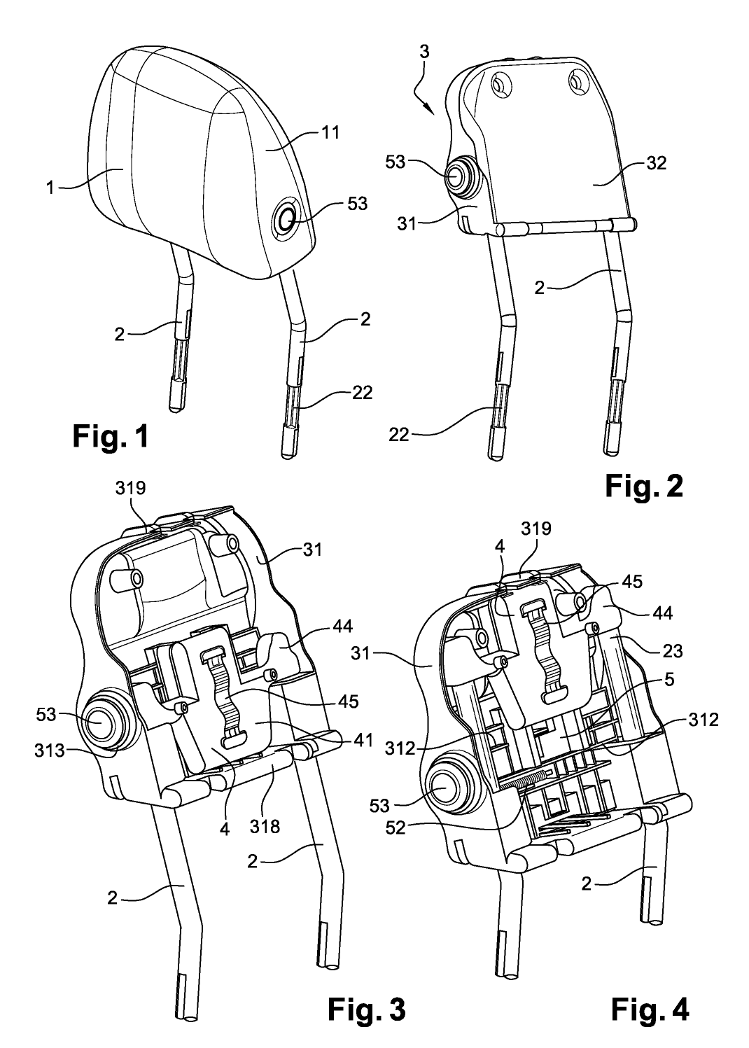

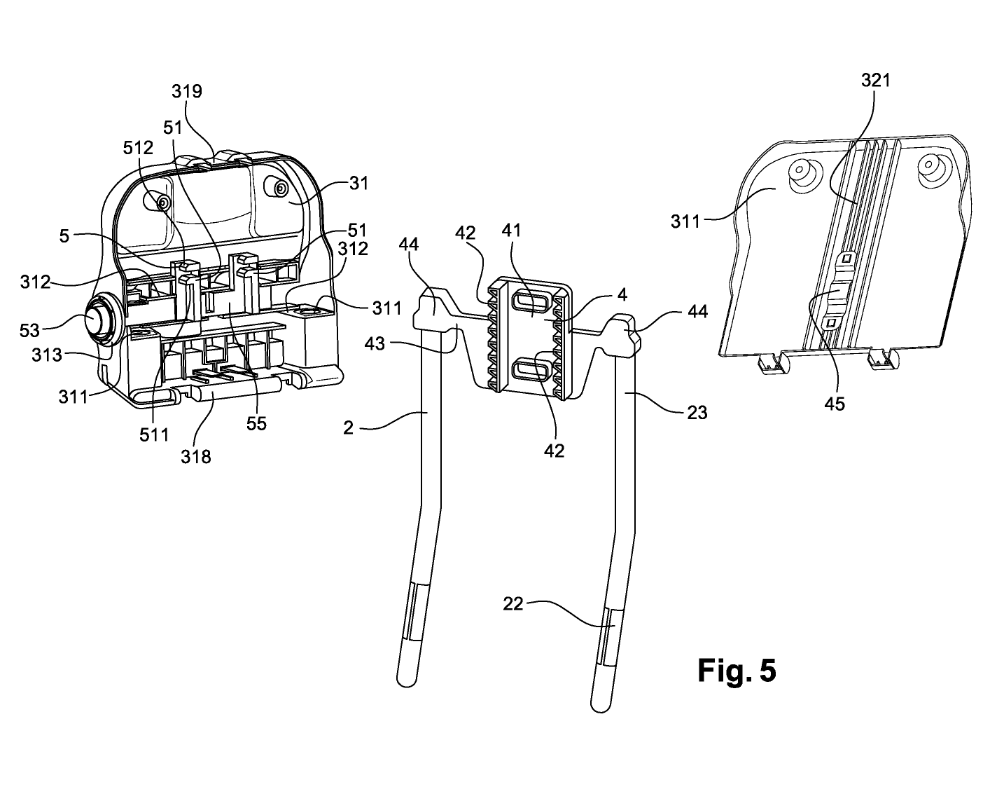

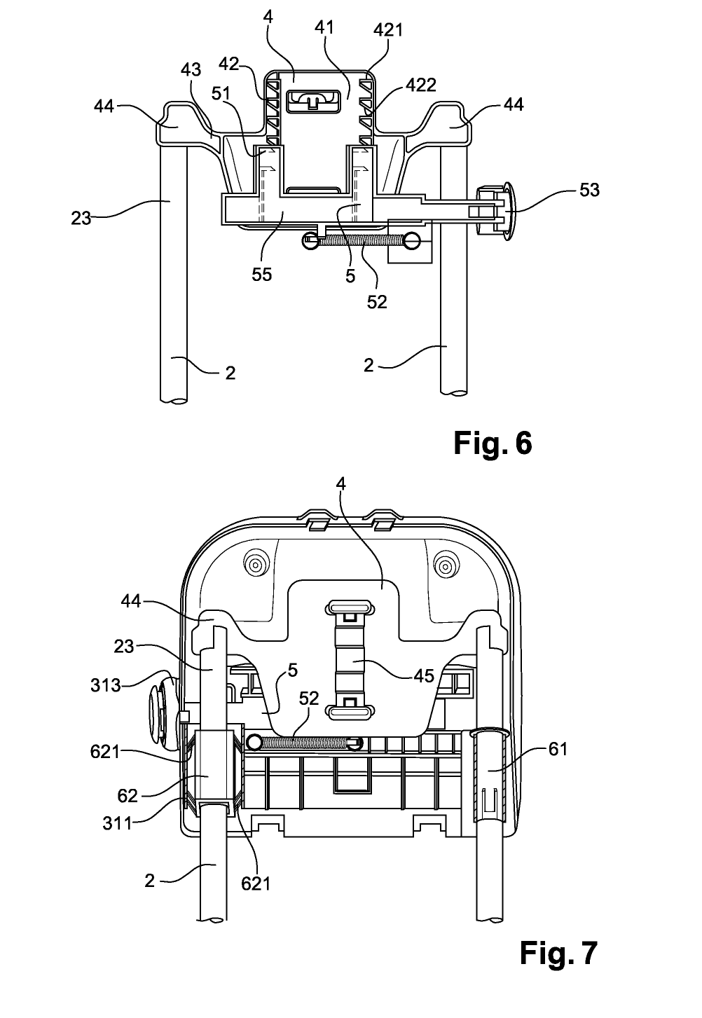

FIG. 1 shows headrest 1 arranged on rods 2, ready to be assembled on a seat backrest, not shown. Rods 2 comprise shapes 22 capable of being inserted and locked in a fixed position in the fastening bushings arranged on top of the seat backrest frame, in known fashion.

The headrest comprises upholstery and a cover 11 covering frame 3 formed of a plastic shell in two parts:
a case 31 slidably assembled on rods 2 and in which is placed a cross-piece 4 connecting rods 2 to a lock 5.
a cover 32 closing the case and hiding the locking system within frame 3.

Bushings 61, 62 are placed in bores 311 made at the bottom and on each side of case 31, the bushings being slidably guided on rods 2. A bushing 61 is simply shrunk in the case bore. The other bushing 62 comprises deformable elements, for example, flexible lips 621, which, by deforming, allow an automatic adjustment of the transversal position of bushing 62 in housing 311 of the case where it is inserted, which enables to automatically adjust the distance from center to center of the bushings to that of the rods, thus avoiding guiding issues that may result from dimensional dispersions of the different parts.

Cross-piece 4 has the general shape of a plate 41 of plastic material comprising, on a surface facing the bottom of the case, two rows of notches 42 extending parallel to the rod direction. The cross-piece comprises arms 43 extending laterally from the plate edges and each comprising a cover 44 force fit on end 23 of a rod. The assembly of the cross-piece and the rods is thus eased; the holding of cross-piece 4 on ends 23 of rods 2 may be completed with pins or the like.

Lock 5 comprises a slide 55 slidably guided, perpendicularly to the axial direction of rods 2, between two ribs 312 formed in case 31, and it is further also guided between the bottom of the case and the surface of plate 41 comprising the rows of notches 42. The lock comprises teeth 51 provided to cooperate with notches 42. A spring 52 pulls back the lock to its locking position, where teeth 51 are engaged with notches 42. Lock 5 comprises a push button 53 placed at its end and jutting out in a bump 313 of case 31, to control the unlocking by a sliding of the lock against the force exerted by spring 52, until teeth 51 are released from notches 42. An elastic blade 314 is formed in the case near bump 313 and elastically presses against the side of lock 5 to avoid clearances which might cause noise between the lock and the case. Another elastic blade 45 is secured to surface 46 of plate 41 opposite to the surface supporting notches 42, and presses on ribs 321 formed in the cover to suppress clearances in the succession of parts in contact formed by case 31, lock 5, cross-piece 4, and cover 32.

Notches 42 have a substantially horizontal upper side 421 and a slanted lower side 422. Teeth 51 have a substantially horizontal lower side 511 and a slanted upper side 512. Thus, the frame may be moved upwards without having to press on push-button 53, the slope of the teeth and of the notches resulting in a ratchet behavior of the lock. Conversely, the horizontal sides of the teeth and of the notches ensure an efficient locking of the headrest, which can only slide downwards by manual unlocking, by sliding of lock 5 to disengage its teeth from notches 42.

It should be noted that, as clearly shown in FIGS. 3 and 4, the shapes and dimensions of cross-piece 4 and of lock 5, as well as those of the case of frame 3, are determined to ensure the desired travel of the headrest, the cross-piece remaining permanently inside of case 31, the bottom 318 of the case leveling the lower edge of plate 41 of cross-piece 4 when the headrest is in high position, and the top 319 of the case leveling the upper edge of plate 41 when the headrest is in low position.

According to the first embodiment just described, cross-piece 4 comprises a plurality of notches 42 distributed along the sliding direction.

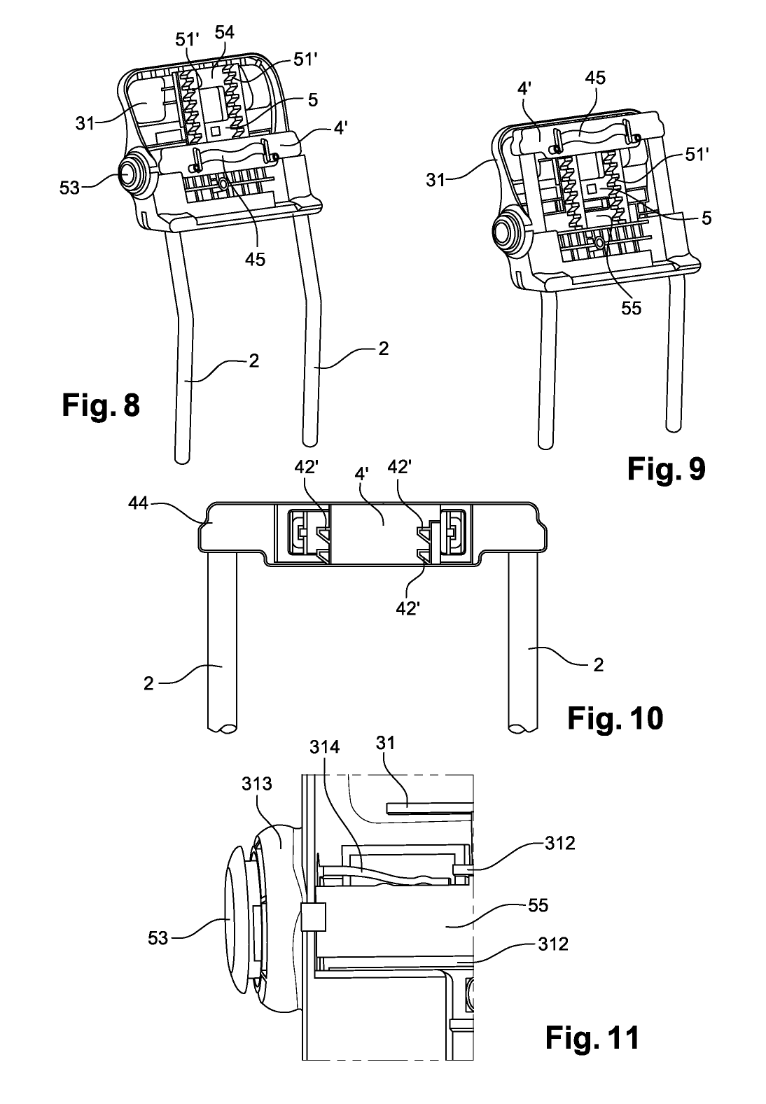

In the second embodiment illustrated in FIGS. 8 to 10, lock 5′ comprises a plurality of teeth 51′ distributed in two rows parallel to the sliding direction on a plate 54 moving along with slide 55. Cross-piece 4′ has a smaller height than in the previous embodiment, and then only comprises a small number of notches per row of teeth, for example, one notch or two notches 42′ as in the shown example. The operation remains quite similar to what has been described hereabove.

Whatever the embodiment, the case, the cover, the cross-piece, and the lock are made of molded plastic material. The headrest can be very simply assembled: bushings 61 and 62 and lock 5 just have to be placed in the case, after which rods 2 have to be inserted into the bushings and cross-piece 4 must be placed on the rod ends, to eventually arrange the cover, which may be snapped on the case, and further secured by screwing.

The present invention is not limited to the above embodiments, which have been described as an example only. In particular, combinations of cross-piece and locks each respectively comprising series of a few notches and teeth may also be used according to needs and to bulk constraints.

Of course, the present invention is likely to have various alterations, modifications, and improvements which will readily occur to those skilled in the art. Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A height-adjustable headrest (1) for an automobile seat backrest, comprising fixed rods (2) intended to be secured to the backrest and extending substantially vertically, a mobile frame (3) slidably assembled on the rods, and a lock associated with the mobile frame and slidably guided thereon along a horizontal direction, to be able to lock the frame on the rods in a plurality of positions, comprising a cross-piece (4) connecting the upper ends of the rods (2), the cross-piece (4) and the lock (5) comprising notches (42, 42′) and teeth (51, 51′) arranged to cooperate together to lock said frame with respect to the cross-piece in any of said plurality of positions.

2. The headrest of claim 1, wherein the cross-piece (4) comprises a plurality of notches (42) distributed along the sliding direction.

3. The headrest of claim 1, wherein the lock (5) comprises a plurality of teeth (51′) distributed along the sliding direction.

4. The headrest of claim 1, comprising elastic return means (52) for pulling back the lock (5) to the position of engagement of the teeth (51) with the notches (42) of the cross-piece (4), and the notches and the teeth have slanted sides (422, 512) so that the lock (5) automatically clenches when the headrest is moved upwards.

5. The headrest of claim 1, wherein the cross-piece (4) comprises arms (43) extending laterally and each comprising a cover (44) force fit on the end (23) of a rod (2).

6. The headrest of claim 1, wherein the mobile frame (3) comprises a case (31) and a cover (32), the case comprises added bushings (61, 62) slidably guided on the rods (2), the lock (5) is slidably guided in the case and comprises a lateral push-button (53), the cross-piece (4) and the rod (5) being entirely hidden in the mobile frame (3) when the cover (32) is attached on the case (31).

7. The headrest of claim 6, wherein one of the bushings (62) for guiding the rods (2) comprises deformable elements (621) enabling to automatically adjust its position in the housing (311) of the case where it is inserted, in the direction perpendicular to the sliding direction of the rods.

8. The headrest of claim 6, wherein the cross-piece (4) is mobile between the lock (5) and the cover (32), and comprises an elastic shoe (45) sliding against the cover,

9. The headrest of claim 6, wherein the case (31), the cover (32), the cross-piece (4), and the lock (5) are made of molded plastic material.
